(19) United States
(12) Patent Application Publication
(10) Pub. No.: US 2002/0049053 A1
(43) Pub. Date: Apr. 25, 2002

(54) Concentrated maintenance management method and concentrated maintenance management system for portable telephone system utilizing the internet

(75) Inventors: Tominari Nomura, Tokyo (JP); Jyoji Oka, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/981,898

(22) Filed: Oct. 19, 2001

(30) Foreign Application Priority Data
Oct. 19, 2000 (JP) 2000-319749

(51) Int. Cl. H04Q 7/20

(52) U.S. Cl. 455/423; 455/426; 455/425

(57) ABSTRACT

The invention provide a centralized maintenance management method and system for a portable telephone system by which fault recovery is performed efficiently. A remote maintenance console for use for maintenance of a portable telephone system accesses a web server of a portable telephone system concentrated maintenance management system over the Internet and searches a database server in which fault data and a diagnosis dictionary are stored to acquire data necessary for fault diagnosis and fault recover. Further, the remote maintenance console is connected to a terminal of a maintenance engineer or a developing engineer in charge of a maker and can receive supporting of maintenance operation on-line from a remote place. Further, request for repair from the remote maintenance console and issuance of a repair acceptance and a repair completion report and report of a repair progress situation from the maker side are performed on-line through an information providing server.

### BACKGROUND OF THE INVENTION

1. Field of the Invention

The present invention relates to a maintenance management technique for a portable telephone system, and more particularly to a concentrated maintenance management method and a concentrated maintenance management system for a portable telephone system which make use of the Internet.

2. Description of the Related Art

Conventionally, if a fault occurs with a portable telephone system, then when a maintenance engineer of a communication undertaker or a maintenance company tries to perform fault recognition, a remote maintenance console is used to recognize the fault based on a rule of thumb (knowledge, experience and so forth of the maintenance engineer).

As a requesting method for repair, a repair request in writing is issued from the communication undertaker or the maintenance company and sent by mail to a maker.

As a repair completion report, the maker sends a repair report by mail to the communication undertaker or the maintenance company after completion of the repair by the maker.

As maintenance, remedial maintenance which is performed after a fault occurs and periodic maintenance (scheduled preventive maintenance) are used. For inventory control of spare panels prepared for possible faults, spare panels are supplemented based on the number of repairs in accordance with a rule of thumb.

Several published documents directed to maintenance of a portable telephone system are available. For example, Japanese Patent No. 2,616,673 discloses a mobile communication system which includes a centralized operational maintenance center including a database for storing fault data and connected to a base station through a mobile communication exchange. The base station reads out data stored in a data save memory circuit of a terminal apparatus over a radio circuit and transfers the data to the database so that, when a communication service of the mobile communication system is faulty, accurate information of the fault can be acquired through an operation input from the mobile terminal. Meanwhile, Japanese Patent Laid-Open No. 173774/1998 discloses a maintenance supporting system which includes maintenance operation step management means for managing steps of a maintenance operation, a portable terminal which allows information exchange between a maintenance engineer and the maintenance operation step management means, and a fixed terminal having a radio communication function, and supports a maintenance operation of a communication network equipment.

In the conventional maintenance management method, when a fault occurs with a portable telephone system, since diagnosis is performed in accordance with a rule of thumb, it relies much upon the skill of the maintenance engineer.

Further, a repair request and a repair completion report are sent by mail. Therefore, much time is required for distribution of them.

Further, a situation of progress of repair of an apparatus or panel which is an object of the repair request is acquired through an inquiry by telephone or the like every time, and this is poor in convenience.

Furthermore, since the conventional system maintenance method employs a remedial maintenance system which uses remedial maintenance, much time is required for fault recovery of the system. Further, since periodic maintenance is performed including additional items which are not prescribed legally, it is not easy to assure a high availability of the system.

In addition, supplementation of spare panels which are prepared against possible faults is based on a rule of thumb. Therefore, the conventional maintenance management method is disadvantageous also in that optimum inventory control cannot be anticipated and excessive or insufficient supplementation is liable to occur.

### SUMMARY OF THE INVENTION

It is an object of the present invention to provide a centralized maintenance management method and a centralized maintenance management system for a portable telephone system by which fault recovery is facilitated.

It is another object of the present invention to provide a centralized maintenance management method and a centralized maintenance management system for a portable telephone system wherein a repair request and a repair completion report can be sent on-line and a situation of repair progress of an object of repair can be accessed on-line.

It is a further object of the present invention to provide a centralized maintenance management method and a centralized maintenance management system for a portable telephone system by which the system availability is improved.

It is a still further object of the present invention to provide a centralized maintenance management method and a centralized maintenance management system for a portable telephone system by which appropriate inventory control can be anticipated.

In order to attain the objects described above, according to an aspect of the present invention, there is provided a centralized maintenance management method for a portable telephone system which makes use of the Internet, comprising the steps of accessing an information providing server of a portable telephone system centralized maintenance management center over the Internet from a maintenance terminal by a maintenance engineer who performs fault diagnosis and recovery operations of the portable telephone system, and searching a database server in which fault data and a diagnosis dictionary are stored through the information providing server so that data necessary for fault diagnosis and fault recovery are acquired by the maintenance terminal.

The maintenance terminal may be connected for communication to terminals of a maintaining engineer and a developing engineer in charge of a maker side of the portable telephone system connected to the portable telephone system concentrated maintenance management center so that the maintenance terminal can enjoy supporting of a maintenance operation on-line from a remote place.

Preferably, contents of the diagnosis dictionary stored in the database server are disclosed through the information providing server.

Preferably, issuance of a repair request from the maintenance terminal and repair acceptance, issuance of a repair completion report and issuance of a repair progress situation report from a maker side are performed on-line through the information providing server.

Preferably, state supervision data of the portable telephone system are collected by the maintenance terminal and transferred to and recorded into the database server through the information providing server, and a terminal of a maker side of the portable telephone system prepares and issues a preventive maintenance schedule based on the state supervision data and the repair data of the database server such that the maintenance terminal can access the preventive maintenance schedule through the information providing server. In this instance, a preventive maintenance operation of the portable telephone system may be performed in accordance with the preventive maintenance schedule produced based on the state supervision data. Otherwise, appropriate inventory management information of apparatus and panels may be calculated based on the preventive maintenance schedule and provided to the maintenance terminal from the information providing server.

According to the present invention, the concentrated maintenance management method provides maintenance operation performed by a communication undertaker which performs maintenance operation of a radio base station and a mobile station of a portable telephone system or a maintenance company entrusted with such maintenance operation and various services for performing maintenance operation and supporting such maintenance operation of the communication undertaker or the maintenance company on-one by connecting, when maintenance operation is entrusted from the communication undertaker or the maintenance company or a request for supporting maintenance operation is received, a portable telephone system concentrated maintenance management center provided in a maker to a remote maintenance console of the communication undertaker side over the Internet.

The following four services are available.

1. The fault recognition supporting service upon occurrence of a fault

This service produces a diagnosis dictionary based on fault repair data (fault examples) received from the remote maintenance console of the communication undertaker and stored and managed in a database server provided in the portable telephone system concentrated maintenance management system and discloses the diagnosis dictionary on-line to support fault recognition.

2. The on-line acceptance and issuance services of a repair request and a repair completion report and the repair progress disclosure service

The services accept a repair request slip of an apparatus or panel, with which a fault occurs, on-line, issues a repair completion report, which is issued upon completion of the repair, on-line, and disclose a repair progress situation to the source of the repair request to provide the convenience.

3. The preventive maintenance schedule preparation service and the preventive maintenance operation service

The services analyze state supervision data collected by the remote maintenance console of the portable telephone system and repair data stored in the database server of the portable telephone system concentrated maintenance management center to produce a preventive maintenance schedule, and perform preventive maintenance operation based on the preventive maintenance schedule to raise the availability of the system.

4. Apparatus and spare panel appropriate inventory management service

The service performs fault occurrence prediction from the repair data and appropriate inventory management of spare panels based on the state supervision data, and manages the inventory of spare panels appropriately in place of the communication undertaker and the maintenance company.

According to another aspect of the present invention, there is provided a centralized maintenance management method for a portable telephone system which makes use of the Internet, comprising the steps of transmitting an inquiry for similar data to a fault of the portable telephone system from a remote maintenance console, which is provided to perform a fault diagnosis operation of the portable telephone system, to a database server through an information providing server of a portable telephone system concentrated maintenance management center to which the remote maintenance console is connected over the Internet, and searching a diagnosis dictionary in the database server having received the inquiry, extracting, when fault data similar to the fault is searched out, the similar fault data and transmitting the similar fault data as a fault inquiry result to the remote maintenance console through the information providing server.

Preferably, the centralized maintenance management method for a portable telephone system further comprises the steps of transmitting, when a fault diagnosis operation is performed by the remote maintenance console and the fault is recovered, fault recovery data to the database server through the information providing server connected over the Internet, and receiving, by the database server, the fault recovery data and updating the fault data and the diagnosis dictionary stored in the database server.

Otherwise, the centralized maintenance management method for a portable telephone system may further comprise the steps of issuing, when data of a similar fault is not searched out from the diagnosis dictionary as a result of the search of the diagnosis dictionary by the database server, from the remote maintenance terminal, a request for supporting of a maintenance operation to a maintenance supporting console of a maintenance engineer or a developing block terminal of a developing engineer in charge of a maker side through the information providing server, and receiving the maintenance supporting information of the maintenance engineer or the developing engineer in charge of the maker side and performing a fault diagnosis operation of the portable telephone system on the remote maintenance console side. In this instance, the centralized maintenance management method for a portable telephone system may further comprise transmitting, when the fault is recovered, fault recovery data from the remote maintenance console to the maintenance supporting console and/or the development block terminal of the maker side to cause the maintenance engineer or the developing engineer in charge of the maker side to confirm the fault recovery data, transmitting the fault recovery data confirmed on the maintenance supporting console and/or the development block terminal by the maintenance engineer or the developing engineer in charge to the database server through the information providing server, and receiving, by the database server, the fault recovery data and updating the fault data and the diagnosis dictionary stored in the database server.

According to a further aspect of the present invention, there is provided a centralized maintenance management method for a portable telephone system which makes use of the Internet, comprising the steps of accessing, when a fault occurs with the portable telephone system and a request for repair of a repair article which is a faulty product or part is to be issued, an information providing server of a portable telephone system concentrated maintenance management center over the Internet from a remote maintenance console provided for performing a fault diagnosis operation of the portable telephone system, inputting repair request contents in accordance with a repair request input form provided by the information providing server and transmitting the repair request information to the information providing server, passing the repair request information received by the information providing server to the database server and cumulatively storing the repair request information as repair request data into the database server, registering a repair return date into the repair request data of the database server in accordance with a repair acceptance input form provided by the information providing server from a remote maintenance supporting console of the portable telephone system concentrated maintenance management center by a maintenance supporting engineer of the portable telephone system concentrated maintenance management center, issuing a repair acceptance slip from the information providing server and transmitting the repair acceptance slip to the remote maintenance console of the repair request destination and a terminal of a repair center by which repair is performed, and inputting a printing instruction of a repair tag card to be applied to the repair article from the terminal of the repair center in accordance with a repair tag print form provided by the information providing server to print a repair tag and applying and sending the repair tag to and together with the repair article to the repair center thereby to complete the on-line repair acceptance service.

Preferably, the centralized maintenance management method for a portable telephone system further comprises the steps of inputting, when the repair of the repair article is completed, repair contents recorded on the repair tag card and a repair completion date in accordance with a repair completion date input form provided by the information providing server and transferring and storing the repair data to and into the database server, and issuing an instruction to issue a repair completion report from the terminal of the repair center, referring to the stored repair data to issue a repair completion report from the information providing server and sending the repair completion report to the remote maintenance console of the repair request destination and a terminal of a distribution center over the Internet thereby to complete the on-line issuance service of a repair completion report.

Otherwise, the centralized maintenance management method for a portable telephone system may further comprise the steps of inputting a repair progress disclosure request from the remote maintenance console in accordance with a repair progress disclosure request form of the information providing server, and extracting, in the database server having received the repair progress disclosure request from the information providing server, identification information of the pertaining repair request article from the repair data stored in the database server and transmitting the extracted data to the remote maintenance console in accordance with an output form of the information providing server.

According to a still further aspect of the present invention, there is provided a centralized maintenance management method for a portable telephone system which makes use of the Internet, comprising a first step of accessing an information providing server of a portable telephone system concentrated maintenance management center over the Internet from a remote maintenance console provided for performing a fault diagnosis operation of the portable telephone system and inputting a preventive maintenance schedule preparation request in accordance with a preventive maintenance schedule preparation input form of the information providing server, a second step of transmitting a state supervision data transfer request from a remote maintenance supporting console of the portable telephone system concentrated maintenance management system to the remote maintenance console through the information providing server, a third step of collecting state supervision data of radio base stations and mobile exchanges of the portable telephone system by the remote maintenance console and transferring the state supervision data to the database server of the portable telephone system concentrated maintenance management center over the Internet so that the state supervision data are stored into the database server, a fourth step of sending an analysis request for the repair data and the state supervision data from the remote maintenance supporting console to the information providing console, analyzing the state supervision data, spare apparatus and panel inventory management data and repair data stored in the database server through the information providing server, performing fault occurrence prediction and determining a failure ratio, calculating required quantities of spare apparatus and panels and storing the required quantities as predictive maintenance schedule data into the database server, and a fifth step of preparing a preventive maintenance schedule by the remote maintenance supporting console based on the preventive maintenance schedule data stored in the database server, storing the preventive maintenance schedule into the database server through the information providing server and transmitting the preventive maintenance schedule to the remote maintenance console in accordance with a preventive maintenance schedule output form of the information providing server.

According to a yet further aspect of the present invention, there is provided a centralized maintenance management method for a portable telephone system which makes use of the Internet, comprising the steps of accessing an information providing server of a portable telephone system concentrated maintenance management center over the internet from a remote maintenance console provided for performing a fault diagnosis operation of the portable telephone system, inputting a service request for apparatus and panel appropriate inventory management in accordance with an appropriate inventory management service request input form of the information providing server and sending the service request to a remote maintenance supporting console of the portable telephone system concentrated maintenance management center, issuing an appropriate inventory data processing request from a maintenance supporting engineer having received the request on the remote maintenance supporting console and performing a preventive maintenance schedule preparation service which includes the second to fifth steps specified as above, executing the preventive maintenance schedule preparation service and issuing an instruction to produce apparatus and panels to a terminal of a production block from the remote maintenance supporting console through the information providing server based on the preventive maintenance schedule obtained by the preventive maintenance schedule preparation service, delivering, after completion of the production, apparatus and panels corresponding to a shortage into a distribution center and performing inventory management in the distribution center, and receiving a notification representing that the appropriate inventory management has been achieved from the terminal of the distribution center by the remote maintenance supporting console through the information providing server and transmitting an appropriate inventory management process completion report to the remote maintenance console of the request destination using an output form of the information providing server.

According to a yet further aspect of the present invention, there is provided a concentrated maintenance management system for a portable telephone system which makes use of the Internet, comprising a plurality of portable telephone systems of one or a plurality of communication undertakers each including a radio base station, a mobile exchange and a remote maintenance console connected to the mobile exchange for performing a fault diagnosis operation of the portable telephone system, the portable telephone systems being connected to each other by a fixed telephone network, the remote maintenance console being connected to a portable telephone system concentrated maintenance management center over the Internet, the portable telephone system concentrated maintenance management center including an information providing server and a database server connected to each other for communication, the remote maintenance console including means for transmitting an inquiry for similar data to a fault of the portable telephone system to the database server through the information providing server of the portable telephone system concentrated maintenance management center connected thereto over the internet, the database server including means for searching a diagnosis dictionary in response to the inquiry, extracting, when fault data similar to the fault is searched out, the similar fault data and transmitting the fault data as a fault inquiry result to the remote maintenance console through the information providing server.

The portable telephone system concentrated maintenance management center may include a satellite ground station so that it can establish a connection for communication to a portable information terminal or a service car owned by a maintenance engineer of the portable telephone system concentrated maintenance management center side by satellite communication. The portable telephone system maybe a personal handyphone system (PHS).

With the concentrated maintenance management methods and the concentrated maintenance management systems for a portable telephone system of the present invention, the following advantages can be anticipated.

The first advantage resides in that maintenance of the portable telephone system can be performed in cooperation with the portable telephone system centralized maintenance management system provided in the maker through the Internet and can be supported on-line from a maintenance engineer or a developing engineer in charge of the system maker thereby to recover the fault efficiently.

The second advantage resides in that a diagnosis dictionary is prepared based on fault data and disclosed on-line to a maintenance engineer thereby to allow a fault recognition supporting service.

The third advantage resides in that maintenance of the portable telephone system can be performed in cooperation with the portable telephone system centralized maintenance management system provided in the maker through the Internet and on-line repair acceptance and issuance of a repair completion report can be performed from the remote maintenance supporting table.

The fourth advantage resides in that a repair progress situation of a faulty apparatus or panel can be disclosed on-line to a maintenance engineer from the remote maintenance console thereby to improve the convenience.

The fifth advantage resides in that maintenance of the portable telephone system can be performed in cooperation with the portable telephone system centralized maintenance management system provided in the maker through the Internet and, based on state supervision data and repair data of the portable telephone system, a fault occurrence prediction and a failure rate (market result value) can be determined to allow a service of preparation of a preventive management schedule and consequently, improvement of the operating ratio can be anticipated.

The sixth advantage resides in that maintenance of the portable telephone system can be performed in cooperation with the portable telephone system centralized maintenance management system provided in the maker through the Internet and, based on preventive maintenance schedule data obtained by the preventive maintenance schedule preparation service, appropriate inventory management of spare apparatus and panels can be achieved.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1. is a block diagram showing a centralized maintenance management system for a portable telephone system to which the present invention is applied;

FIGS. 2 and 3 are flow charts illustrating a processing procedure of the centralized maintenance management system of FIG. 1;

FIGS. 4 to 7 are flow charts illustrating another processing procedure of the centralized maintenance management system of FIG. 1;

FIG. 8 is a schematic view showing an example of a screen display of a fault similar data inquiry input format used in the centralized maintenance management system of FIG. 1;

FIG. 9 is a similar view but showing an example of a display screen of a fault similar data inquiry result used in the centralized maintenance management system of FIG. 1;

FIG 10 is a similar view but showing an example of a display screen of a fault processing result input format used in the centralized maintenance management system of FIG. 1;

FIG. 11 is a similar view but showing an example of a display screen of a fault recovery data input format used in the centralized maintenance management system of FIG. 1;

FIG. 12 is a similar view but showing an example of a display screen of an apparatus, panel repair request input format used in the centralized maintenance management system of FIG. 1;

FIG. 13 is a similar view but showing an example of a display screen of an input format for an apparatus, panel repair acceptance slip used in the centralized maintenance management system of FIG. 1;

FIG. 14 is a similar view but showing an example of a display screen of an output of the apparatus, panel repair acceptance slip used in the centralized maintenance management system of FIG. 1;

FIG. 15 is a similar view but showing an example of a display screen of an apparatus, panel repair tag print used in the centralized maintenance management system of FIG. 1;

FIG. 16 is a similar view but showing an example of an input display screen of an apparatus, panel repair completion date used in the centralized maintenance management system of FIG. 1;

FIG. 17 is a similar view but showing an example of a display screen of an apparatus, panel repair expense report used in the centralized maintenance management system of FIG. 1;

FIG. 18 is a similar view but showing an example of a display screen of an input format of an apparatus, panel repair progress disclosure request used in the centralized maintenance management system of FIG. 1;

FIG. 19 is a similar view but showing an example of a display screen of an apparatus, panel repair progress disclosure used in the centralized maintenance management system of FIG. 1;

FIG. 20 is a similar view but showing an example of a display screen of an input format for a system preventive maintenance schedule used in the centralized maintenance management system of FIG. 1;

FIG. 21 is a similar view but showing an example of a display screen of a system preventive maintenance schedule output used in the centralized maintenance management system of FIG. 1;

FIG. 22 is a similar view but showing an example of a display screen of an input format of a spare apparatus, appropriate inventory management service request used in the centralized maintenance management system of FIG. 1; and

FIG. 23 is a similar view but showing an example of a display screen of a spare apparatus, appropriate inventory management service output used in the centralized maintenance management system of FIG. 1,

### DESCRIPTION OF THE PREFERRED EMBODIMENT

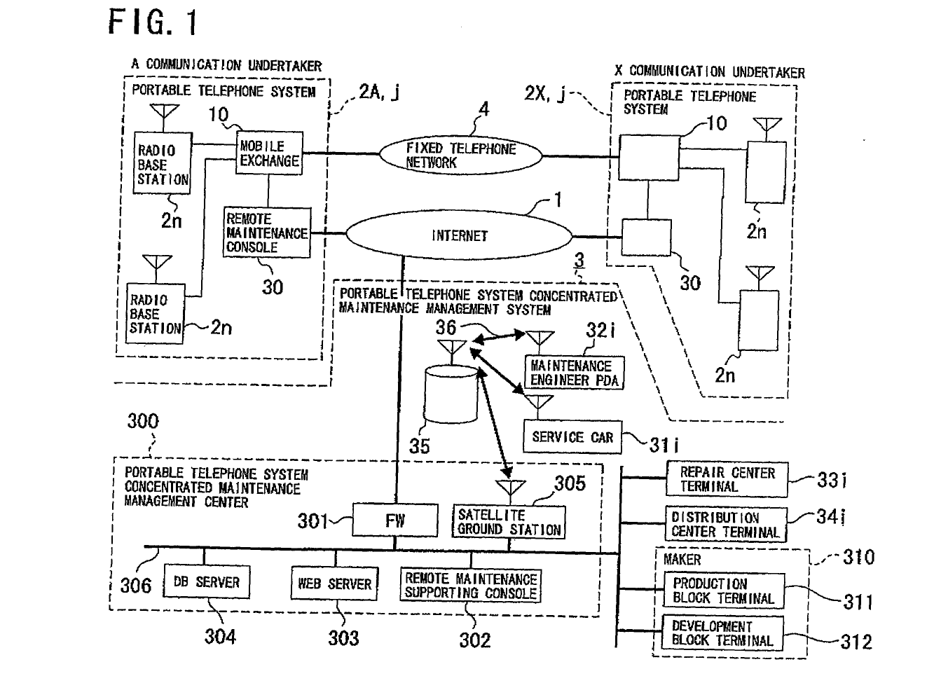

Referring to FIG. 1, there is shown an example of a system configuration of a centralized maintenance management system to which the present invention is applied. Radio base stations 2n (n is an integer equal to or greater than 1) of a portable telephone system 2A, j of an A communication undertaker and radio base stations 2n (n is an integer equal to or greater than 1) of another portable telephone system 2X, j of an X communication undertaker other than the A communication undertaker are connected to a mobile exchange 10 which serves as a higher-rank apparatus. The portable telephone systems 2A,j and 2X,j are connected to the mobile exchange 10 each by a fixed telephone network 4 thereof, and a remote maintenance console 30 is connected to each of the mobile exchanges 10. It is to be noted that, while the portable telephone system of the A communication undertaker and the portable telephone system of the X communication undertaker are shown in FIG. 1, naturally the present invention is not limited to a system configuration of portable communication systems of two communication undertakers.

A configuration for providing various services of the portable telephone systems is described below.

The remote maintenance console 30 of each of the portable telephone systems 2A,j and 2X,j is connected to a portable telephone system concentrated maintenance management system 3 through the Internet 1. The portable telephone system concentrated maintenance management system 3 is connected to a stationary satellite 35, a portable telephone system concentrated maintenance management center 300, a service car 31i, a maintenance engineer portable digital assistant (hereinafter referred to as maintenance engineer PDA) 32i, a repair center terminal 33i, a distribution center terminal 34i (i here indicates an integer equal to or greater that 1), and terminals of a maker 310.

The terminals of the maker 310 include a production block terminal 311 and a development block terminal 312 both connected to an intra-network 306.

The portable telephone system concentrated maintenance management center 300 includes a firewall (FW) 301, a remote maintenance supporting console 302, an information disclosure server (hereinafter referred to as web server) 303, a database server (hereinafter referred to as DB server) 304, and a satellite ground station 305 all connected to the intra-network 306.

The satellite ground station 305, stationary satellite 35, maintenance engineer PDA32i and service car 31i are connected each other by a microwave circuit 36 so that each of the maintenance engineer PDA 32i and the service car 31i can communicate with the portable telephone system concentrated maintenance management center 300 through the stationary satellite 35 which can cover a side area. The service car 31i has spare panels, apparatus and parts carried thereon in order to prepare for an urgent fault.

The remote maintenance consoles 30 of the portable telephone systems 2A,j and 2X,j and the remote maintenance supporting console 302 of the portable telephone system concentrated maintenance management center 300 are connected to each other through the firewall 301 over the Internet 1.

Operation of the concentrated maintenance management system described above is described for each service (business model).

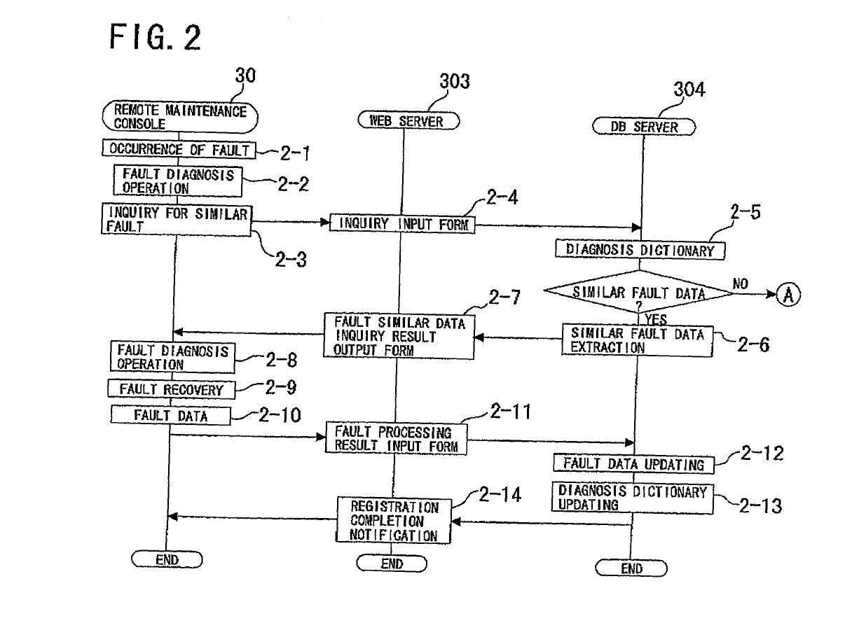

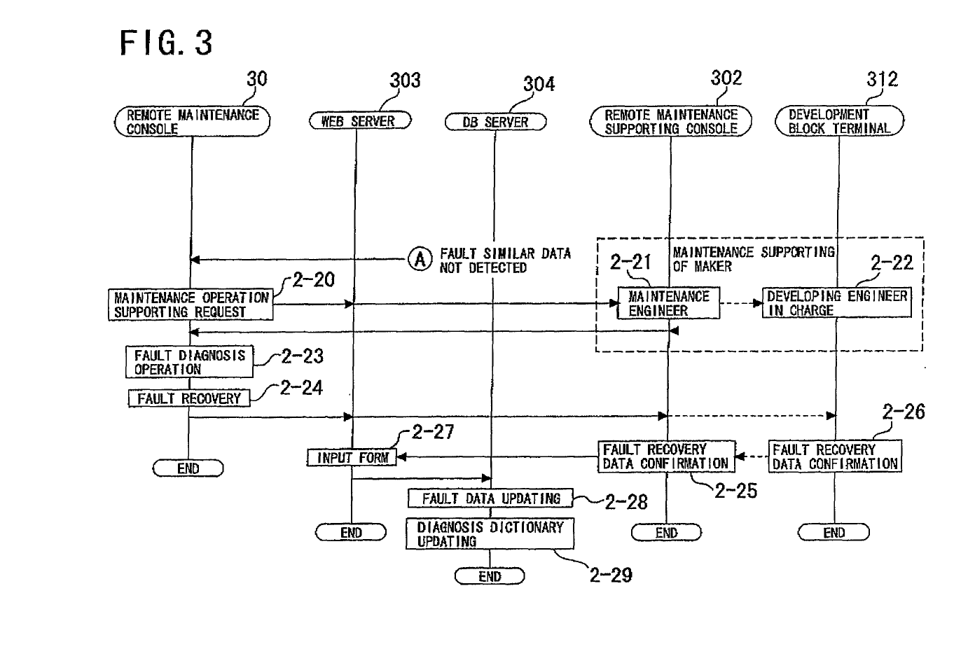

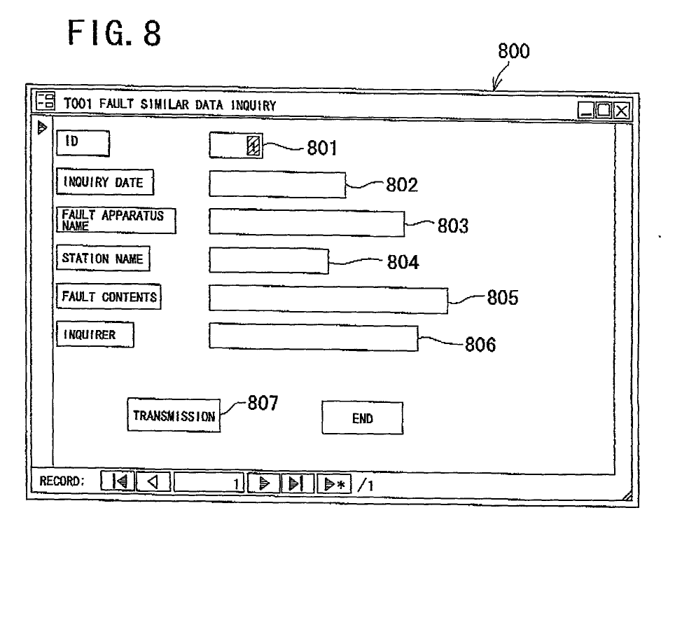

First, a fault recognition supporting service upon occurrence of a fault is described with reference to FIGS. 1 to 3 and 8 to 11. FIGS. 2 and 3 illustrate processing by a portable telephone system, and FIGS. 8 to 11 show screen information transferred to and displayed on a terminal (the remote maintenance console 30).

If a fault occurs with the portable telephone system 2A,j or the portable telephone system 2X,j (step 2-1 of FIG. 2), then a maintenance engineer of the communication undertaker or a maintenance company will use the remote maintenance console 30 to perform a fault diagnosis operation (step 2-2 of FIG. 2).

Then, in the process of the diagnosis by the maintenance engineer of the communication undertaker, the maintenance engineer will use the remote maintenance console 30 to issue an inquiry (step 2-3 of FIG. 2) for fault similar data to the DB server 304 through the web server 303 of the portable telephone system concentrated maintenance management center 300 over the Internet 1 in accordance with a “fault similar data inquiry” input form (refer to FIG. 8) displayed on the remote maintenance console 30 (step 2-4). As the fault similar data inquiry input form, such a input form 80 as shown in FIG. 8 is displayed on a display unit of the remote maintenance console 30 which accesses the web server 303, and the maintenance engineer of the communication undertaker will input an ID, an inquiry date, a fault apparatus name, a station name, fault contents and an inquirer into input columns 801 to 806, respectively, through the screen and then depresses a transmission button 807.

Now, operation of the portable telephone system when similar fault data is found in response to the inquiry for fault similar data is described.

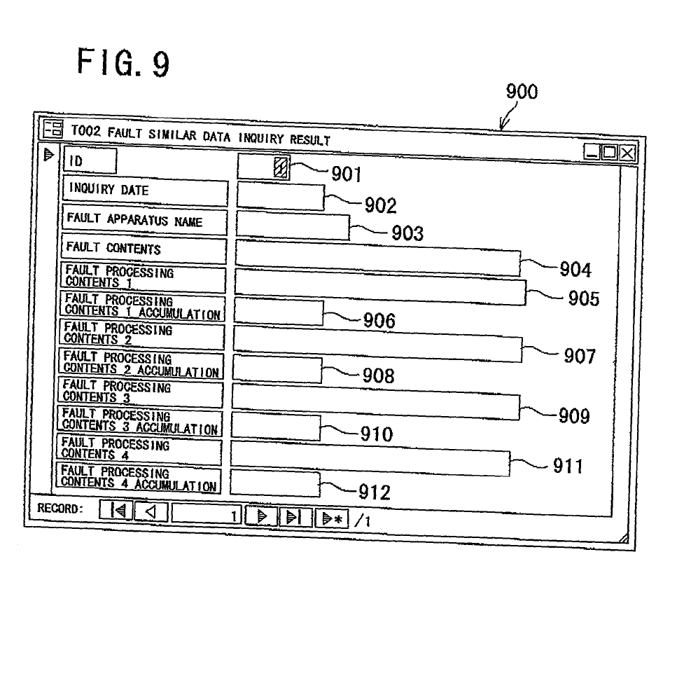

In response to the inquiry for fault similar data, a diagnosis dictionary stored in the DB server 304 is searched (step 2-5 of FIG. 2), and similar fault data which may possibly make a cause of the fault is extracted (step 2-6 of FIG. 2). Then, the web server 303 receives the similar fault data from the DB server 304 and transfers data in accordance with such a “fault similar data inquiry result” output form 900 as shown in FIG. 9 to the remote maintenance console 30 operated by the maintenance engineer over the Internet 1 (step 2-7 of FIG. 2). Referring to FIG. 9, according to the “fault similar data inquiry result” output form 900, an ID, an inquiry date, a fault apparatus name, and fault processing contents and accumulations of them (results of accumulation of the fault processing contents in the past) for a plurality of fault contents are displayed in output columns 901 to 912.

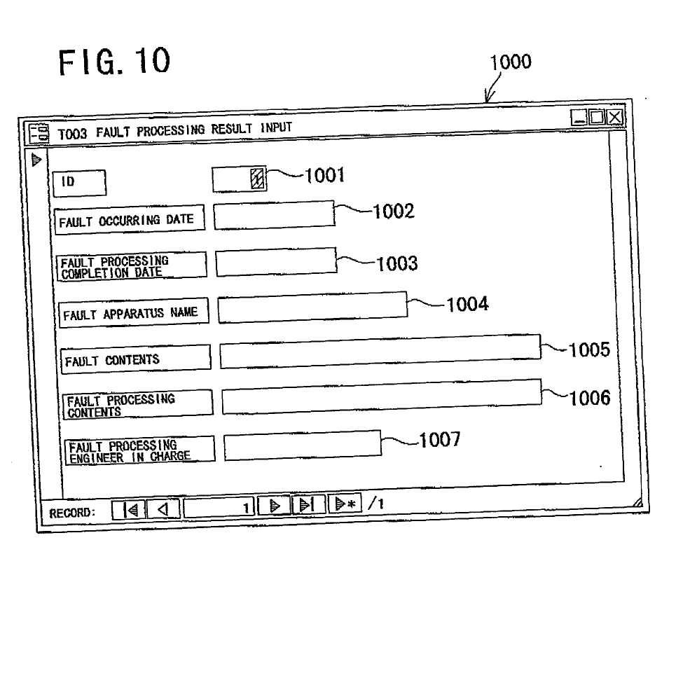

The maintenance engineer will perform a fault diagnosis operation based on the fault similar data transferred to the remote maintenance console 30 (step 2-8 of FIG. 2). Then, if the fault is recovered, then the maintenance engineer will input fault recovery data from the remote maintenance console 30 (steps 2-9 and 2-10 of FIG. 2). In this instance, the maintenance engineer will access the web server 303 of the portable telephone system concentrated maintenance management center 300 over the Internet 1, input in accordance with such a “fault processing result input” form 1000 as shown in FIG. 10 (step 2-11 of FIG. 2) and then update the fault data and the diagnosis dictionary stored in the DB server 304 (steps 2-12 and 2-13 of FIG. 2). Referring to FIG. 10 according to the “fault processing result input” form 1000, information of an ID, a fault occurring date, a fault processing completion date, a fault apparatus name, fault contents, fault processing contents and a fault processing engineer in charge is inputted to input columns 1001 to 1007, respectively.

After the updating of the fault data and the diagnosis dictionary in the DB server 304 is completed, a fault data completion registration notification is issued from the web server 303 (step 2-14 of FIG. 2), thereby completing the fault recognition supporting service when similar data is found in the diagnosis dictionary.

Now, operation of the portable telephone system when fault similar data is not found in the diagnosis dictionary in response to the inquiry for fault similar data is described.

When fault similar data is not found in the diagnosis dictionary, the maintenance engineer of the communication undertaker will use the remote maintenance console 30 to issue a maintenance operation supporting request (step 2-20 of FIG. 3). In response to the maintenance operation supporting request, a maintenance engineer of the maker will operate the remote maintenance console 30 over the Internet 1 from the remote maintenance supporting console 302 to support the fault diagnosis operation (steps 2-21 and 2-22 of FIG. 3).

On the other hand, if the maintenance engineer of the maker having received the maintenance supporting request cannot deal with this, a developing engineer in charge in a development section will operate the development block terminal 312 connected to the Internet 1 to support the fault diagnosis operation through the remote maintenance supporting console 302 (steps 2-22 and 2-23 of FIG. 3).

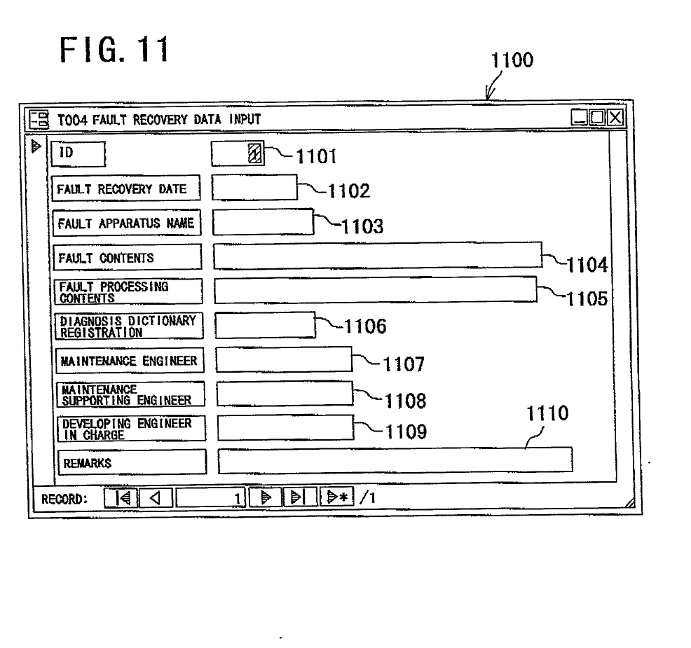

If the fault is recovered through the support of the maintenance engineer and the developing engineer of the maker (step 2-24 of FIG. 3), then fault recover data is confirmed by the maintenance engineer and the developing engineer of the maker through the web server 303 (steps 2-25 and 2-26) and then inputted in accordance with such a “fault recovery data input” form 1100 as shown in FIG. 11 (step 2-27 of FIG. 3). Then, the fault data stored in the DB server 304 are updated and the diagnosis dictionary is updated (steps 2-28 and 2-29 of FIG. 3), thereby completing the fault discrimination supporting service when similar data is not found in the diagnosis dictionary. Referring to FIG. 11, according to the “fault recovery data input” form 1100, information regarding an ID, a fault recovery date, a fault apparatus name, fault contents, fault processing contents, diagnosis dictionary registration, a maintenance engineer, a maintenance supporting engineer, a developing engineer in charge and remarks is inputted to input columns 1101 to 1110, respectively.

The apparatus or panel with which the fault has occurred is sent from a repair requesting person to the repair center through the distribution center and repaired in the repair center. The apparatus or panel suffering from the fault is returned to the repair requesting person through the distribution center after the repair thereof in the repair center is completed.

The fault recognition supporting service upon occurrence of a fault described above allows cooperation with a portable telephone system centralized maintenance management system provided in a maker through the Internet so that maintenance of a portable telephone system can be supported on-line from a maintenance engineer or a developing engineer in charge of the system maker thereby to recover the fault efficiently.

The fault recognition supporting service upon occurrence of a fault uses a diagnosis dictionary based on fault data and discloses the diagnosis dictionary on-line to a maintenance engineer to allow a fault recognition supporting service.

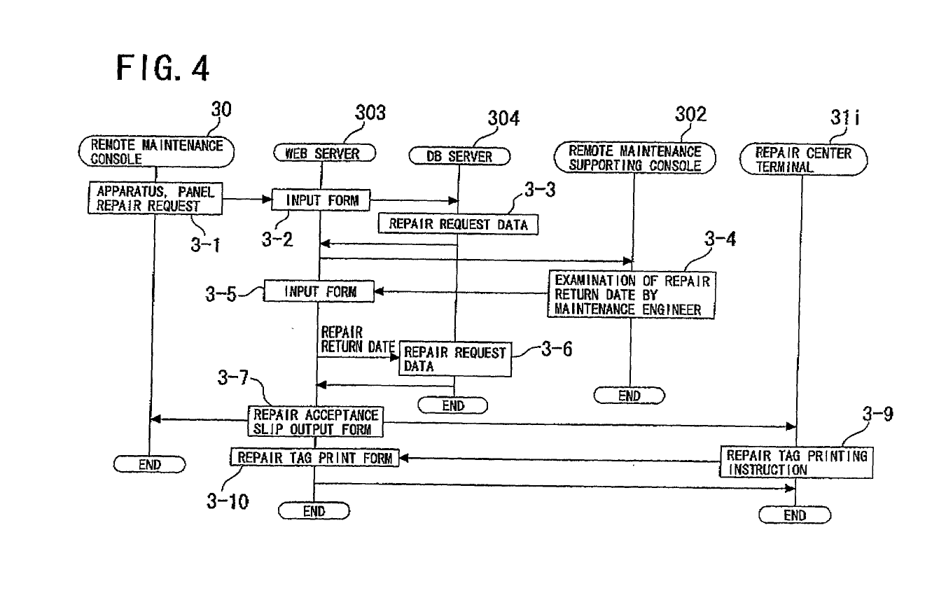

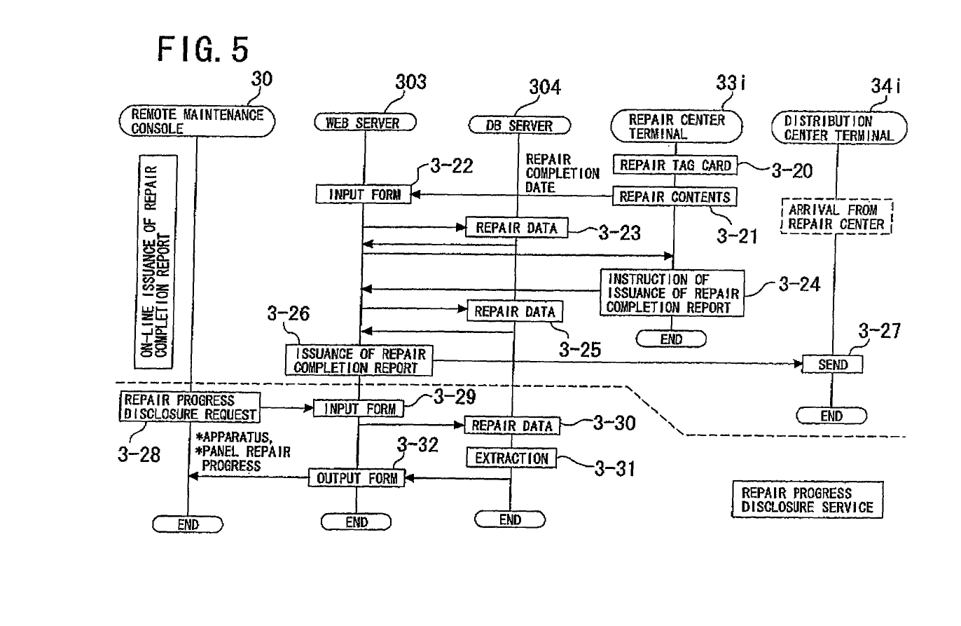

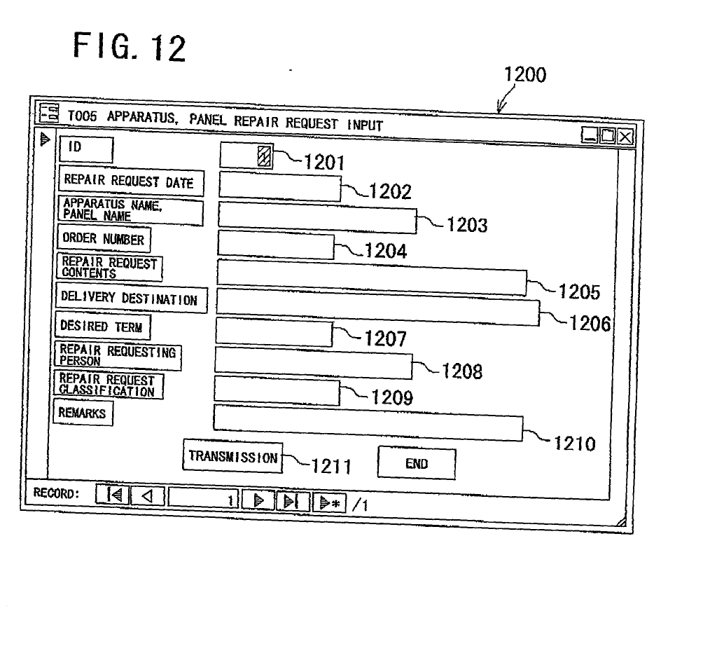

Now, an on-line acceptance and issuance service of a repair request and a repair completion report and a repair progress disclosure service are described with reference to FIGS. 1, 4, 5 and 12 to 19. FIGS. 4 and 5 are flow charts illustrating a processing procedure of the services, and FIG. 12 to 19 show screen displays (forms) used in the services.

First, when a repair request for an apparatus or a panel with which a fault occurs is issued from a remote maintenance console 30 (step 3-1 of FIG. 4), repair request contents are inputted in accordance with such an “apparatus, panel repair request input” form 1200 as shown in FIG. 12 of the web server 303 of the portable telephone system concentrated maintenance management center 300 over the Internet 1 (step 3-2 of FIG. 4). When the input is completed, the inputted information is transmitted. Referring to FIG. 12, according to the “apparatus, panel repair request input” form 1200, information regarding an ID, a repair requesting date, an apparatus name, panel name, the order number, repair request contents, a delivery destination, a desired delivery term, a repair requesting person, a repair request classification and remarks is inputted to input columns 1201 to 1210, respectively. After the information is inputted, a transmission button 1211 will be depressed to transmit the apparatus, panel repair request input (electronic repair request) to the web server 303.

The electronic repair request received by the web server 303 is cumulatively stored as repair request data into the DB server 304 (step 3-3 of FIG. 4).

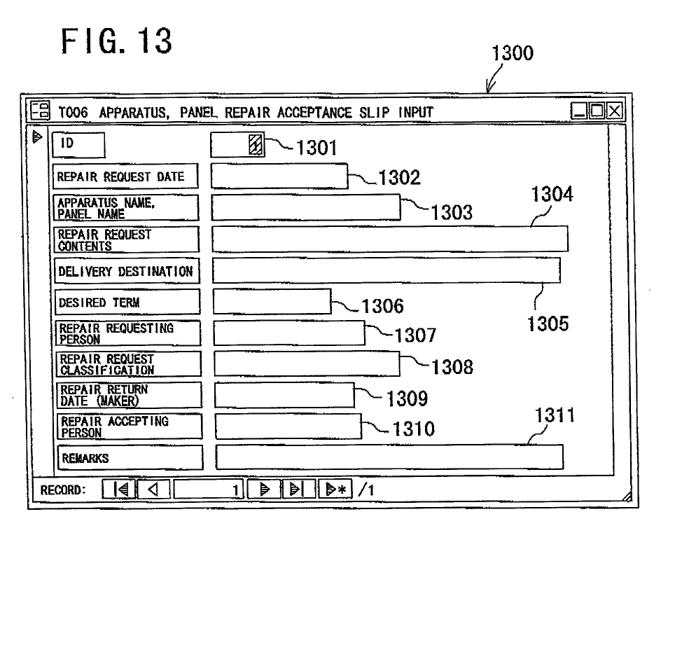

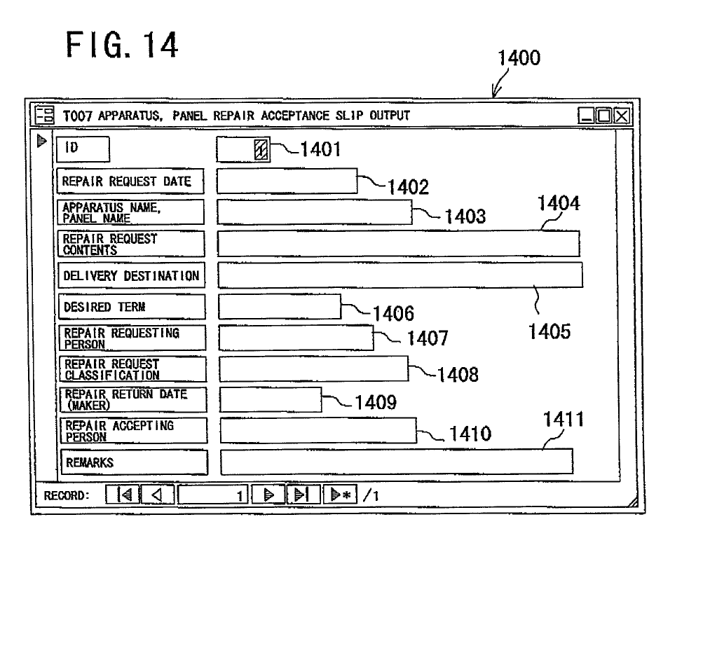

Then, a maintenance supporting person of the portable telephone system concentrated maintenance management center 300 will examine a repair return approximate date (step 3-4) and input necessary information, in accordance with such an “apparatus, panel repair acceptance input” form 1300 as shown in FIG. 13, into input columns 1301 to 1311 for an ID, a repair request date, an apparatus name-panel name, repair request contents, a delivery destination, a desired delivery term, a repair requesting person, a repair request classification, a repair return date, a repair accepting person and remarks to write the information into repair request data of the DB server 304 (steps 3-5 and 3-6 of FIG. 4). Then, such an apparatus, panel repair acceptance slip output (electronic repair acceptance slip) form 1400 as shown in FIG. 14 is issued from the web server 303 (step 3-7 of FIG. 4) and transmitted to the remote maintenance console 30 of the repair request destination and the repair center terminal 33i. Referring to FIG. 14, the apparatus, panel repair acceptance slip output form 1400 includes output columns 1401 to 1411 for an ID, a repair request date, an apparatus name, panel name, repair request contents, a delivery destination, a desired delivery term, a repair requesting person, a repair request classification, a repair return date, a repair accepting person and remarks.

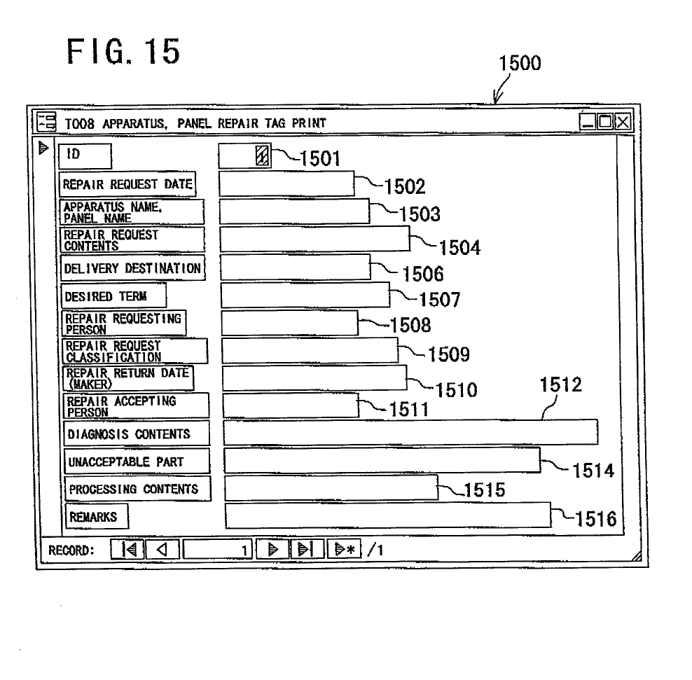

Then, the repair center terminal 33i issues a printing instruction to print a repair tag card to be applied to the apparatus or panel of the object of the repair request in accordance with such a repair tag printing form 1500 as shown in FIG. 15 and sends the repair article with the printed repair tag applied thereto to the repair center (steps 3-9 and 3-10 of FIG. 4), thereby completing the on-line repair acceptance service. Referring to FIG. 15, the repair tag printing form 1500 includes output columns 1501 to 1516 for an ID, a repair request date, an apparatus name, panel name, repair request contents, a delivery destination, a desired delivery term, a repair requesting person, a repair request classification, a repair return date, a repair accepting person, diagnosis contents, unacceptable parts, processing contents and remarks

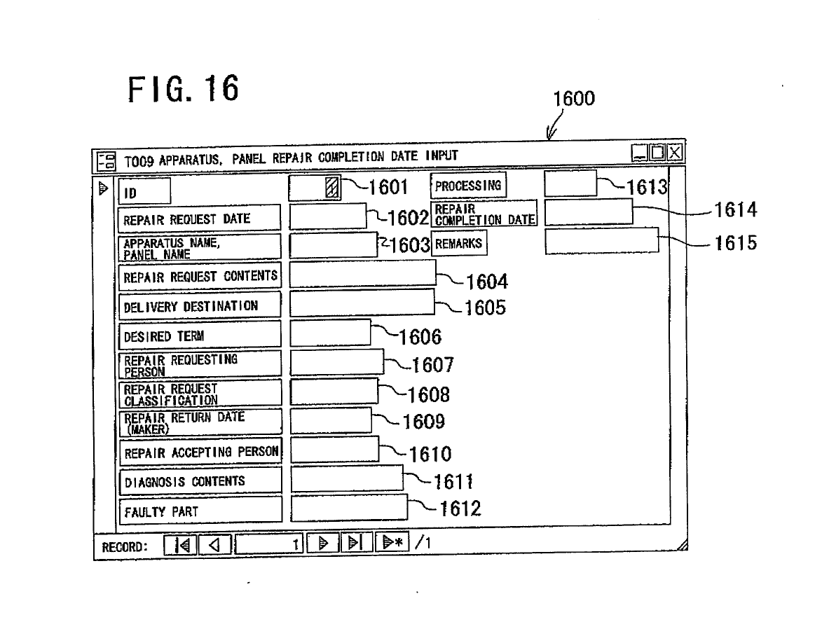

In the on-line issuance service of a repair completion report, after the repair of the apparatus or panel of the object of the repair request is completed, the repair contents written on the repair tag card and the repair completion date are inputted in accordance with such an “apparatus, panel repair completion date input” form 1600 as shown in FIG. 16 of the web server 303 (steps 8-20 to 3-22 of FIG. 5), and the repair data are stored into the DB server 304 (step 3-23 of FIG. 5). Referring to FIG. 16, the apparatus, panel repair completion date input form 1600 includes input columns 1601 to 1615 for an ID, a repair request date, an apparatus name, panel name, repair request contents, a delivery destination, a desired delivery term, a repair requesting person, a repair request classification, a repair return date, a repair accepting person, diagnosis contents, unacceptable parts, processing, a repair completion date and remarks.

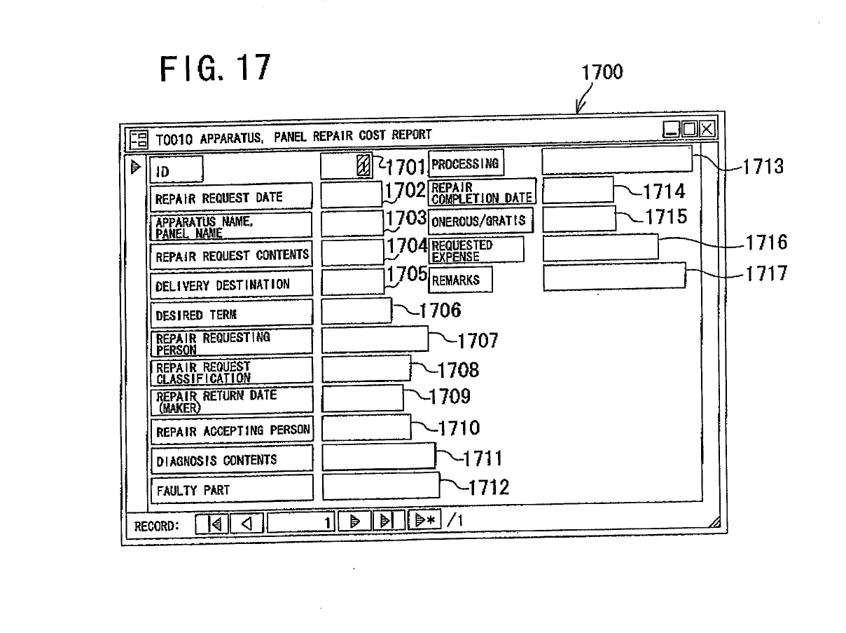

Then, an instruction to issue a repair completion report is issued from the repair center terminal 33i (step 3-24 of FIG. 5), and the stored repair data are referred to (step 3-25 of FIG. 5) and such a “repair completion report” form 1700 as shown in FIG. 17 of the web server 303 is issued (step 3-26 of FIG. 5). Then, the repair completion report is sent to the remote maintenance console 30 of the repair request destination and the distribution terminal 34i over the Internet 1 (step 3-27 of FIG. 5), thereby completing the on-line issuance service of are pair completion report. Referring to FIG. 17, the “repair completion report” form 1700 includes output columns 1701 to 1717 for an ID, a repair request date, an apparatus name, panel name, repair request contents, a delivery destination, a desired delivery term, a repair requesting person, a repair request classification, a repair return date, a repair accepting person, diagnosis contents, faulty parts, processing, a repair completion date, onerous/gratis, requested expense and remarks.

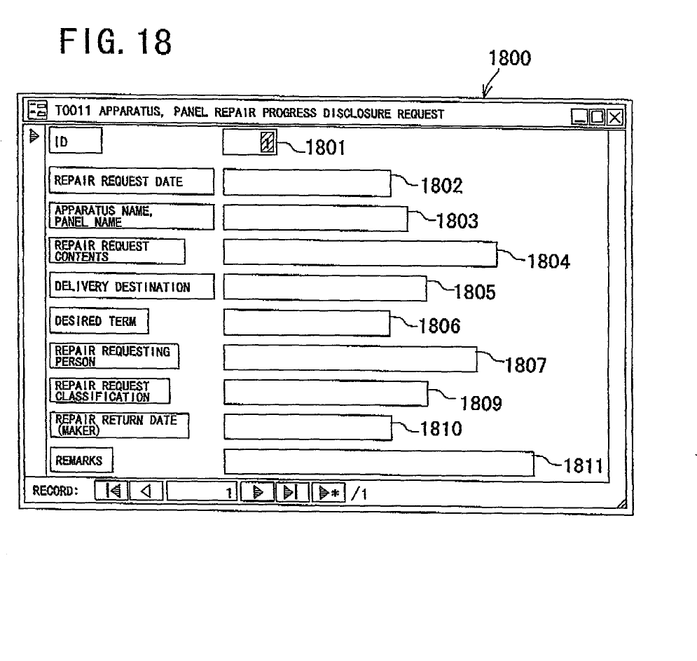

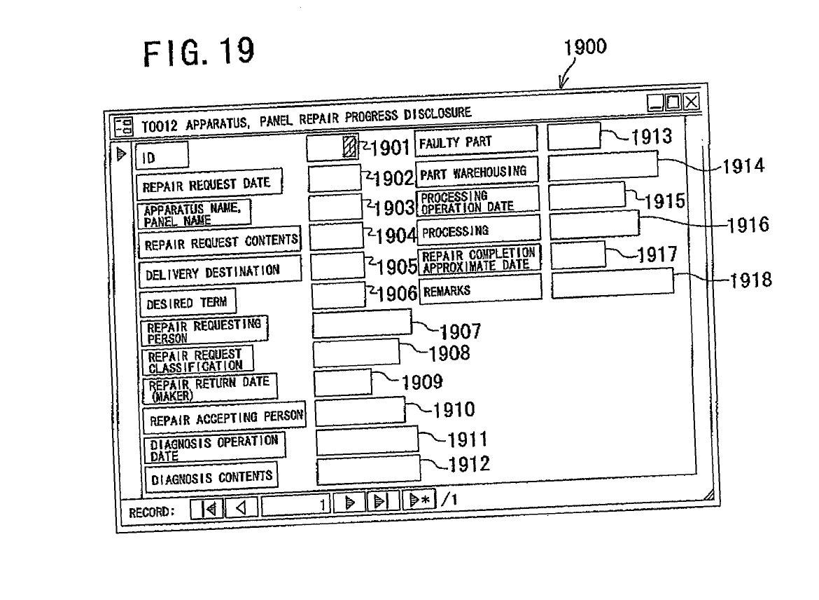

Then, in the repair progress disclosure service, an order number of a name of an apparatus or a panel whose repair progress is desired to know is inputted from the remote maintenance console 30 in accordance with such an “apparatus, panel repair progress disclosure request” form 1800 as shown in FIG. 18 of the web server 303 to issue a repair progress disclosure request (steps 3-28 and 3-29 of FIG. 5). Then, an ID number of the pertaining repair request is extracted from the repair data stored in the DB server 304 (steps 3-30 and 3-31 of FIG. 5), and the extracted data is sent in accordance with such an output form 1900 as shown in FIG. 19 of the web server 303 to the remote maintenance console 30 (step 3-32 of FIG. 5), thereby completing the on-line repair progress disclosure service. Referring to FIG. 18, the apparatus, panel repair progress disclosure request form 1800 includes input columns 1801 to 1811 for an ID, a repair request date, an apparatus name, panel name, repair request contents, a delivery destination, a desired delivery term, a repair requesting person, a repair request classification, a repair return date and remarks. Referring to FIG. 19, the apparatus, panel repair progress disclosure form 1900 includes output columns 1901 to 1918 for an ID, are pair request date, an apparatus name, panel name, repair request contents, a delivery destination, a desired destination term, a repair requesting person, a repair request classification, a repair return date, a repair accepting person, a repair operation date, diagnosis contents, faulty parts, part warehousing, a processing operation date, processing, a repair completion approximate date and remarks.

The on-line acceptance and issuance service of a repair request and a repair completion report and the repair progress disclosure service described above allow cooperation with a portable telephone system centralized maintenance management system provided in a maker through the Internet to perform maintenance of a portable telephone system so that on-line repair acceptance and issuance of a repair completion report can be performed from a remote maintenance supporting table.

Further, with the on-line acceptance and issuance service of a repair request and a repair completion report and the repair progress disclosure service, a repair progress situation of a faulty apparatus or panel can be disclosed on-line to a maintenance engineer from the remote maintenance console thereby to improve the convenience.

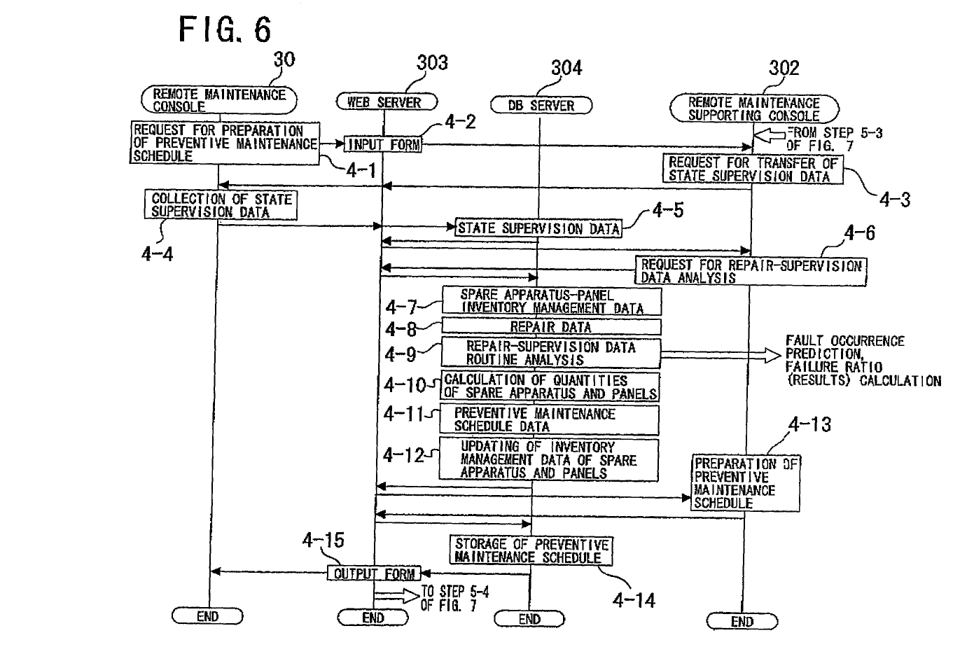

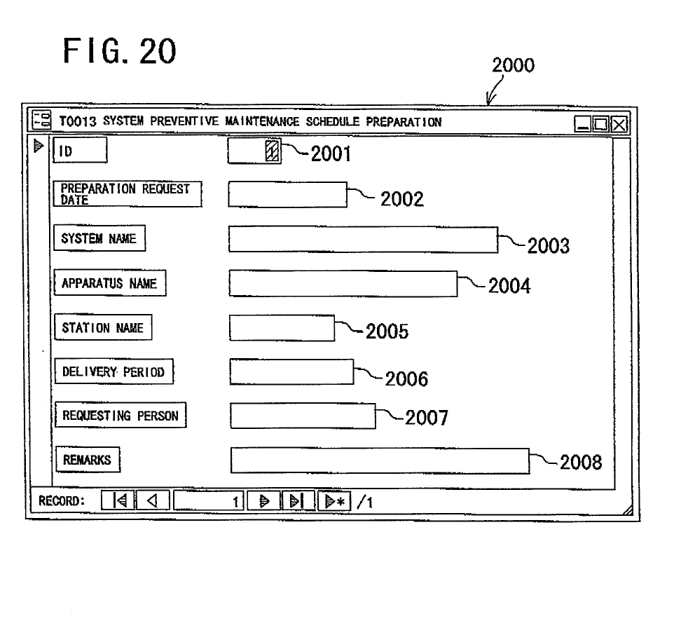

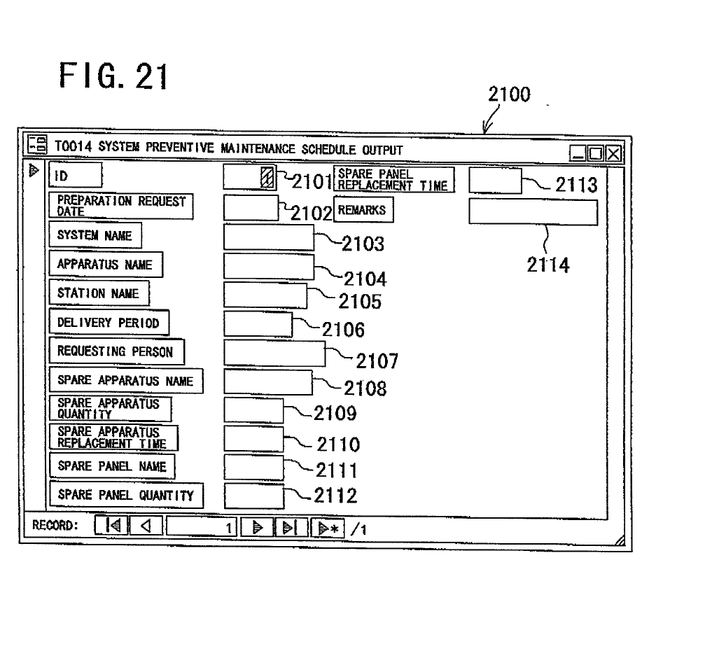

Now, a preventive maintenance schedule preparation service and a preventive maintenance working service are described with reference to FIGS. 1, 6, 20 and 21. FIG. 6 illustrates a processing procedure of the services, and FIGS. 20 and 21 show screen displays (forms).

First, a preventive maintenance schedule preparation request is inputted from a remote maintenance console 30 in accordance with such a “system preventive maintenance schedule preparation input” form 2000 as shown in FIG. 20 of the web server 303 (steps 4-1 and 4-2 of FIG. 6). Referring to FIG. 20, the “system preventive maintenance schedule preparation input” form 2000 includes input columns 2001 to 2008 for an ID, a preparation request date, a system name, an apparatus name, a station name, a delivery period, a requesting person and remarks.

Then, a state supervision data transfer request is sent from the remote maintenance supporting console 802 to the remote maintenance console 30 through the web server 303 (step 4-3 of FIG. 6).

Then, the remote maintenance console 30 collects state supervision data of the radio base stations 2n and the mobile exchange 10 (step 4-4 of FIG. 6) and stores the state supervision data into the DB server 304 over the Internet 1 (step 4-5 of FIG. 6).

Then, an analysis request for the repair data and statue supervision data is sent from the remote maintenance supporting console 302 to the web server 303 (step 4-6 of FIG. 6), and the state supervision data, spare apparatus, panel inventory management data stored in the DB server 304 are analyzed through the web server 303 (steps 4-7 and 4-8 of FIG. 6). Then, a fault occurrence prediction and market actual results of the fault rate are determined to catch a sign of a fault and the quantities of spare apparatus and panels are calculated (steps 4-9 and 4-10 of FIG. 6). Then, the quantities of spare apparatus and panels calculated are stored as preventive maintenance schedule data into the DB server 304 (step 4-11 of FIG. 6).

Then, the spare apparatus, panel inventory management data are updated (step 4-12 of FIG. 6), and a preventive maintenance schedule is prepared on the terminal of the remote maintenance supporting console 302 based on the stored preventive maintenance schedule data (step 4-13 of FIG. 6). After the preparation is completed, the preventive maintenance schedule is sent in accordance with such a system preventive maintenance schedule output form 2100 as shown in FIG. 21 of the web server 303 thereby to complete the preventive maintenance schedule preparation service. Referring to FIG. 21, the system preventive maintenance schedule output form 2100 shown includes output columns 2101 to 2114 for an ID, a preparation request date, a system name, a station name, a delivery period, a requesting person, a spare apparatus name, a spare apparatus quantity, a spare apparatus replacement time, a spare panel name, a spare panel quantity, a spare panel replacement time and remarks.

Thereafter, in the preventive maintenance business service, preventive maintenance operation is performed based on the preventive maintenance schedule in place of the communication undertaker or the maintenance company.

The preventive maintenance schedule preparation service and the preventive maintenance working service described above allow cooperation with a portable telephone system centralized maintenance management system provided in a maker through the Internet so that maintenance of a portable telephone system can be performed, Further, based on state supervision data and repair data of the portable telephone system, a fault occurrence prediction and a failure rate (market result value) are determined to allow a service of preparation of a preventive management schedule. Consequently, improvement of the operating ratio can be anticipated.

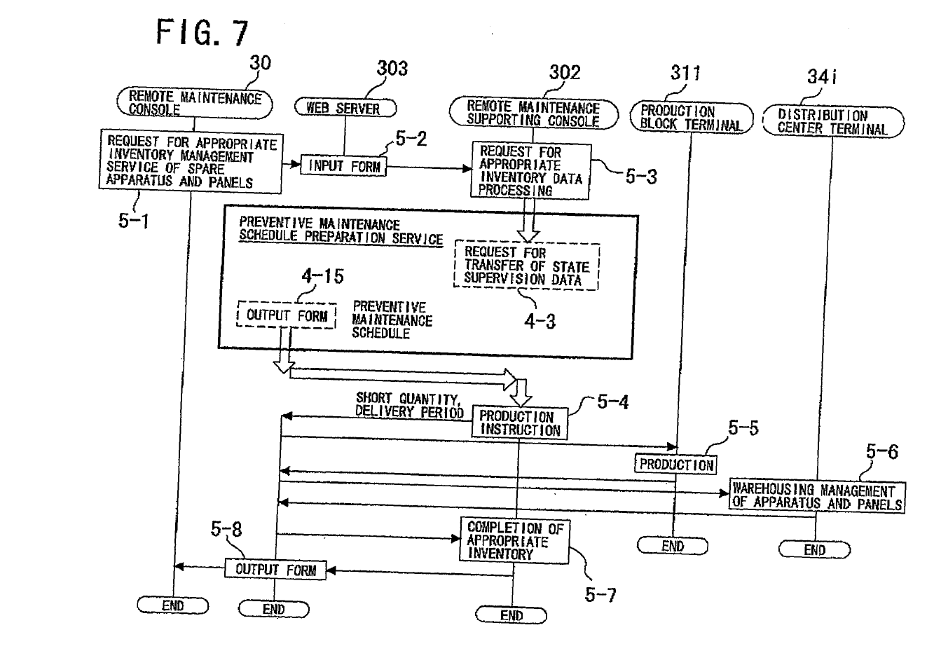

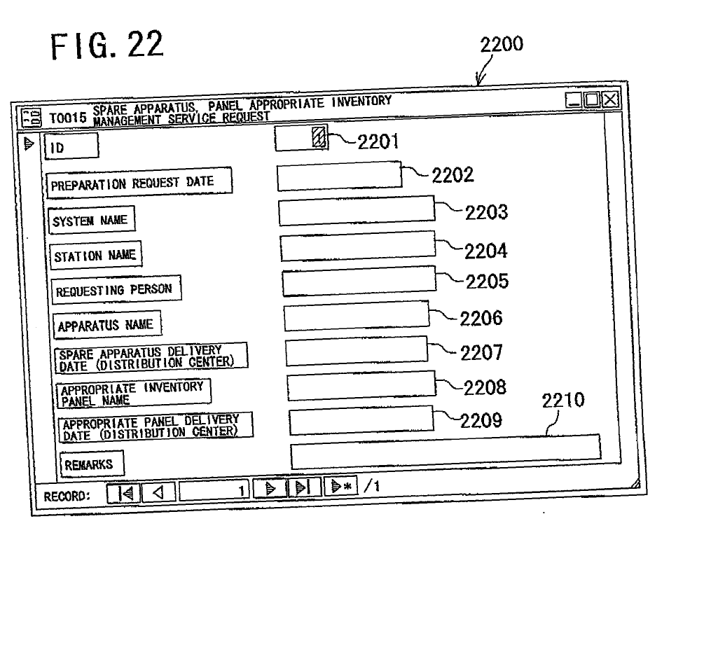

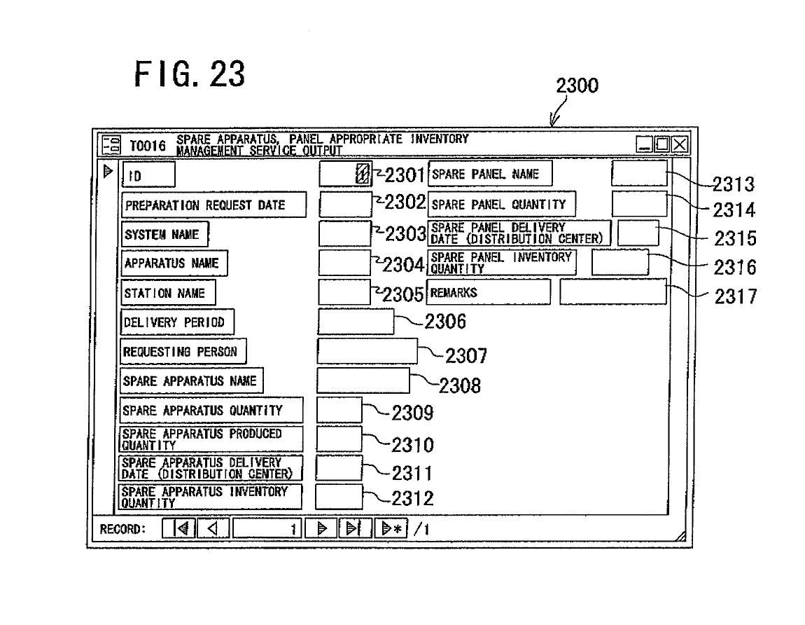

Now, an apparatus, spare panel appropriate inventory management service is described with reference to FIGS. 1, 7, 22 and 23. FIG. 7 illustrates a processing procedure of the service, and FIGS. 22 and 23 show screen displays (forms) used in the process.

First, a service request for apparatus, panel appropriate inventory management is inputted from a remote maintenance console 30 in accordance with such a “spare apparatus, appropriate inventory management service request” input form 2200 as shown in FIG. 22 and is sent to the remote maintenance supporting console 302 (steps 5-l and 5-2 of FIG. 7). Referring to FIG. 22, the “spare apparatus, appropriate inventory management service request” input form 2200 includes input columns 2201 to 2210 for an ID, a preparation request date, a system name, a station name, a requesting person, an apparatus name, a spare apparatus delivery date (distribution center), an appropriate inventory panel name, an appropriate panel delivery date (distribution center) and remarks.

A maintenance supporting engineer receiving the request performs a preventive maintenance schedule preparation service in accordance with the appropriate inventory data processing request (step 5-3 of FIG. 7), whereafter the processing advances to the state supervision data transfer requesting step 4-3 of FIG. 6, in which the preventive maintenance schedule preparation service is executed. Then, based on the preventive maintenance schedule obtained by the preventive maintenance schedule preparation service, an instruction to manufacture the apparatus and the panel is issued from the remote maintenance supporting console 302 to the production block terminal 311 through the web server 303 (step 5-4 of FIG. 7). After the manufacture is completed (step 5-5 of FIG. 7), those apparatus and panels corresponding to the shortage are delivered to the distribution center, by which inventory management is performed (step 5-6 of FIG. 7).

A notification representing that appropriate inventory management is prepared from the distribution center terminal 34i is received by the remote maintenance supporting console 302 through the web server 303, and the remote maintenance supporting console 302 transmits an appropriate inventory control processing completion report to the remote maintenance console 30 using such a spare apparatus, appropriate inventory management output form 2300 as shown in FIG. 23 of the web server 303 (steps 5-7 and 5-8 of FIG. 7), thereby completing the spare apparatus, panel appropriate inventory management service.

Referring to FIG. 23, the spare apparatus, appropriate inventory management output form 2300 includes output columns 2301 to 2317 for an ID, a preparation request date, a system name, an apparatus name, a station name, a delivery period, a requesting person, a spare apparatus name, a spare apparatus quantity, a spare apparatus production quantity, a spare apparatus delivery date (distribution center), a spare apparatus inventory quantity, a spare panel name, a spare panel quantity, a spare delivery date (distribution center), a spare panel inventory quantity and remarks.

The apparatus, spare panel appropriate inventory management service described above allows cooperation with a portable telephone system centralized maintenance management system provided in a maker through the Internet so that maintenance of a portable telephone system can be performed. Further, based on preventive maintenance schedule data obtained by the preventive maintenance schedule preparation service, appropriate inventory management of spare apparatus and panels can be achieved.

While a preferred embodiment of the present invention has been described using specific terms including several screen forms which may be used therein, such description is for illustrative purposes only, and it is to be understood that changes and variations may be made without departing from the spirit or scope of the following claims.

What is claimed is:

1. A centralized maintenance management method for a portable telephone system which makes use of the Internet, comprising the steps of:
accessing an information providing server of a portable telephone system centralized maintenance management center over the Internet from a maintenance terminal by a maintenance engineer who performs fault diagnosis and recovery operations of said portable telephone system; and
searching a database server in which fault data and a diagnosis dictionary are stored through said information providing server so that data necessary for fault diagnosis and fault recovery are acquired by said maintenance terminal.

2. A centralized maintenance management method for a portable telephone system as claimed in claim 1, wherein said maintenance terminal is connected for communication to terminals of a maintaining engineer and a developing engineer in charge of a maker side of said portable telephone system connected to said portable telephone system concentrated maintenance management center so that said maintenance terminal can enjoy supporting of a maintenance operation on-line from a remote place.

3. A centralized maintenance management method for a portable telephone system as claimed in claim 1, wherein contents of said diagnosis dictionary stored in said database server are disclosed through said information providing server.

4. A centralized maintenance management method for a portable telephone system as claimed in claim 1, wherein issuance of a repair request from said maintenance terminal and repair acceptance, issuance of a repair completion report and issuance of a repair progress situation report from a maker side are performed on-line through said information providing server.

5. A centralized maintenance management method for a portable telephone system as claimed in claim 1, wherein state supervision data of said portable telephone system are collected by said maintenance terminal and transferred to and recorded into said database server through said information providing server, and a terminal of a maker side of said portable telephone system prepares and issues a preventive maintenance schedule based on the state supervision data and the repair data of said database server such that said maintenance terminal can access the preventive maintenance schedule through said information providing server.

6. A centralized maintenance management method for a portable telephone system as claimed in claim 5, wherein a preventive maintenance operation of said portable telephone system is performed in accordance with the preventive maintenance schedule produced based on the state supervision data.

7. A centralized maintenance management method for a portable telephone system as claimed in claim 5, wherein appropriate inventory management information of apparatus and panels is calculated based on the preventive maintenance schedule and provided to said maintenance terminal from said information providing server.

8. A centralized maintenance management method for a portable telephone system which makes use of the Internet, comprising the steps of:
transmitting an inquiry for similar data to a fault of said portable telephone system from a remote maintenance console, which is provided to perform a fault diagnosis operation of said portable telephone system, to a database server through an information providing server of a portable telephone system concentrated maintenance management center to which said remote maintenance console is connected over the Internet; and
searching a diagnosis dictionary in said database server having received the inquiry, extracting, when fault data similar to the fault is searched out, the similar fault data and transmitting the similar fault data as a fault inquiry result to said remote maintenance console through said information providing server.

9. A centralized maintenance management method for a portable telephone system as claimed in claim 8, further comprising the steps of:
transmitting, when a fault diagnosis operation is performed by said remote maintenance console and the fault is recovered, fault recovery data to said database server through said information providing server connected over the Internet; and
receiving, by said database server, the fault recovery data and updating the fault data and the diagnosis dictionary stored in said database server.

10. A centralized maintenance management method for a portable telephone system as claimed in claim 8, further comprising the steps of:
issuing, when data of a similar fault is not searched out from said diagnosis dictionary as a result of the search of said diagnosis dictionary by said database server, from said remote maintenance terminal, a request for supporting of a maintenance operation to a maintenance supporting console of a maintenance engineer or a developing block terminal of a developing engineer in charge of a maker side through said information providing server; and
receiving the maintenance supporting information of the maintenance engineer or the developing engineer in charge of the maker side and performing a fault diagnosis operation of said portable telephone system on said remote maintenance console side.

11. A centralized maintenance management method for a portable telephone system as claimed in claim 10, further comprising:
transmitting, when the fault is recovered, fault recovery data from said remote maintenance console to said maintenance supporting console and/or said development block terminal of the maker side to cause the maintenance engineer or the developing engineer in charge of the maker side to confirm the fault recovery data;
transmitting the fault recovery data confirmed on said maintenance supporting console and/or said development block terminal by the maintenance engineer or the developing engineer in charge to said database server through said information providing server; and
receiving, by said database server, the fault recovery data and updating the fault data and the diagnosis dictionary stored in said database server.

12. A centralized maintenance management method for a portable telephone system which makes use of the Internet, comprising the steps of:
accessing, when a fault occurs with said portable telephone system and a request for repair of a repair article which is a faulty product or part is to be issued, an information providing server of a portable telephone system concentrated maintenance management center over the Internet from a remote maintenance console provided for performing a fault diagnosis operation of said portable telephone system, inputting repair request contents in accordance with a repair request input form provided by said information providing server and transmitting the repair request information to said information providing server;
passing the repair request information received by said information providing server to said database server and cumulatively storing the repair request information as repair request data into said database server;
registering a repair return date into the repair request data of said database server in accordance with a repair acceptance input form provided by said information providing server from a remote maintenance supporting console of said portable telephone system concentrated maintenance management center by a maintenance supporting engineer of said portable telephone system concentrated maintenance management center;
issuing a repair acceptance slip from said information providing server and transmitting the repair acceptance slip to said remote maintenance console of the repair request destination and a terminal of a repair center by which repair is performed; and
inputting a printing instruction of a repair tag card to be applied to the repair article from said terminal of said repair center in accordance with a repair tag print form provided by said information providing server to print a repair tag and applying and sending the repair tag to and together with the repair article to said repair center thereby to complete the on-line repair acceptance service.

13. A centralized maintenance management method for a portable telephone system as claimed in claim 12, further comprising the steps of:
inputting, when the repair of the repair article is completed, repair contents recorded on the repair tag card and a repair completion date in accordance with a repair completion date input form provided by said information providing server and transferring and storing the repair data to and into said database server; and
issuing an instruction to issue a repair completion report from said terminal of said repair center, referring to the stored repair data to issue a repair completion report from said information providing server and sending the repair completion report to said remote maintenance console of the repair request destination and a terminal of a distribution center over the Internet thereby to complete the on-line issuance service of a repair completion report.

14. A centralized maintenance management method for a portable telephone system as claimed in claim 12, further comprising the steps of:
inputting a repair progress disclosure request from said remote maintenance console in accordance with a repair progress disclosure request form of said information providing server; and
extracting, in said database server having received the repair progress disclosure request from said information providing server, identification information of the pertaining repair request article from the repair data stored in said database server and transmitting the extracted data to said remote maintenance console in accordance with an output form of said information providing server.

15. A centralized maintenance management method for a portable telephone system which makes use of the Internet, comprising:
a first step of accessing an information providing server of a portable telephone system concentrated maintenance management center over the Internet from a remote maintenance console provided for performing a fault diagnosis operation of said portable telephone system and inputting a preventive maintenance schedule preparation request in accordance with a preventive maintenance schedule preparation input form of said information providing server;
a second step of transmitting a state supervision data transfer request from a remote maintenance supporting console of said portable telephone system concentrated maintenance management system to said remote maintenance console through said information providing server;
a third step of collecting state supervision data of radio base stations and mobile exchanges of said portable telephone system by said remote maintenance console and transferring the state supervision data to said database server of said portable telephone system concentrated maintenance management center over the Internet so that the state supervision data are stored into said database server;
a fourth step of sending an analysis request for the repair data and the state supervision data from said remote maintenance supporting console to said information providing console, analyzing the state supervision data, spare apparatus and panel inventory management data and repair data stored in said data base server through said information providing server, performing fault occurrence prediction and determining a failure ratio, calculating required quantities of spare apparatus and panels and storing the required quantities as predictive maintenance schedule data into said database server; and
a fifth step of preparing a preventive maintenance schedule by said remote maintenance supporting console based on the preventive maintenance schedule data stored in said database server, storing the preventive maintenance schedule into said database server through said information providing server and transmitting the preventive maintenance schedule to said remote maintenance console in accordance with a preventive maintenance schedule output form of said information providing server.

16. A centralized maintenance management method for a portable telephone system which makes use of the Internet, comprising the steps of:
accessing an information providing server of a portable telephone system concentrated maintenance management center over the internet from a remote maintenance console provided for performing a fault diagnosis operation of said portable telephone system, inputting a service request for apparatus and panel appropriate inventory management in accordance with an appropriate inventory management service request input form of said information providing server and sending the service request to a remote maintenance supporting console of said portable telephone system concentrated maintenance management center;
issuing an appropriate inventory data processing request from a maintenance supporting engineer having received the request on said remote maintenance supporting console and performing a preventive maintenance schedule preparation service which includes the second to fifth steps of claim 15;
executing the preventive maintenance schedule preparation service and issuing an instruction to produce apparatus and panels to a terminal of a production block from said remote maintenance supporting console through said information providing server based on the preventive maintenance schedule obtained by the preventive maintenance schedule preparation service;
delivering, after completion of the production, apparatus and panels corresponding to a shortage into a distribution center and performing inventory management in said distribution center; and
receiving a notification representing that the appropriate inventory management has been achieved from said terminal of said distribution center by said remote maintenance supporting console through said information providing server and transmitting an appropriate inventory management process completion report to said remote maintenance console of the request destination using an output form of said information providing server.

17. A concentrated maintenance management system for a portable telephone system which makes use of the Internet, comprising:
a plurality of portable telephone systems of one or a plurality of communication undertakers each including a radio base station, a mobile exchange and a remote maintenance console connected to said mobile exchange for performing a fault diagnosis operation of the portable telephone system;
said portable telephone systems being connected to each other by a fixed telephone network;
said remote maintenance console being connected to a portable telephone system concentrated maintenance management center over the Internet;
said portable telephone system concentrated maintenance management center including an information providing server and a database server connected to each other for communication;
said remote maintenance console including means for transmitting an inquiry for similar data to a fault of the portable telephone system to said database server through said information providing server of said portable telephone system concentrated maintenance management center connected thereto over the internet;
said database server including means for searching a diagnosis dictionary in response to the inquiry, extracting, when fault data similar to the fault is searched out, the similar fault data and transmitting the fault data as a fault inquiry result to said remote maintenance console through said information providing server.

18. A centralized maintenance management system for a portable telephone system as claimed in claim 17, wherein said remote maintenance console performs a fault diagnosis operation and, when the fault is recovered, transmits fault recovery data to said database server through said information providing server connected over the Internet, and said database server includes dictionary updating means for receiving the fault recovery data and updating the fault data and the diagnosis dictionary stored in said database server.

19. A centralized maintenance management system for a portable telephone system as claimed in claim 17, wherein a maintenance supporting console of a maintenance engineer or a developing block terminal of a developing engineer in charge of a maker side is connected to said portable telephone system concentrated maintenance management center, and when data of a similar fault is not searched out from said diagnosis dictionary as a result of the search of said diagnosis dictionary by said database server, said remote maintenance terminal establishes a connection for communication to said maintenance supporting console or developing block terminal and issues a request for supporting of a maintenance operation and then performs a fault diagnosis operation of said portable telephone system on said remote maintenance console side under maintenance supporting of the maintenance engineer or the developing engineer in charge of the maker side.

20. A centralized maintenance management system for a portable telephone system as claimed in claim 17, wherein said remote maintenance console includes transmission means for transmitting, when the fault is recovered, fault recovery data to said maintenance supporting console and/or said development block terminal of the maker side, and said database server includes dictionary updating means for receiving, when the maintenance engineer or the developing engineer in charge of the maker side confirms the fault recovery data and transmits the confirmed fault recovery data from said maintenance supporting console and/or said development block terminal to said database server through said information providing server, the fault recovery data and updating the fault data and the diagnosis dictionary stored in said database server.

21. A centralized maintenance management system for a portable telephone system as claimed in claim 17, wherein a terminal of a repair center and a terminal of a distribution center are connected for communication to said portable telephone system concentrated maintenance management center, said remote maintenance console accessing, when a request for repair of a repair article which is a product or part of an object of repair of said portable telephone system is to be issued, said information providing server, inputting repair request contents in accordance with a repair request input form provided by said information providing server and transmitting the repair request information to said information providing server, the repair request information received by said information providing server being passed to said database server, said database server cumulatively storing the repair request information as repair request data, a repair return date being registered into the repair request data of said database server in accordance with a repair acceptance input form provided by said information providing server by a maintenance supporting engineer of said portable telephone system concentrated maintenance management center, and said information providing server includes transmission means for electronically issuing a repair acceptance slip and transmitting the repair acceptance slip to said remote maintenance console of the repair request destination and said terminal of said repair center.

22. A centralized maintenance management system for a portable telephone system as claimed in claim 21, wherein a printing instruction of a repair tag card to be applied to the repair article is issued from said terminal of said repair center in accordance with a repair tag print form provided by said information providing server to print a repair tag by a printer, and the repair article with the repair tag applied thereto is sent to said repair center.

23. A centralized maintenance management system for a portable telephone system as claimed in claim 21, wherein, when the repair of the repair article is completed, repair contents recorded on the repair tag card and a repair completion date are inputted in accordance with a repair completion date input form provided by said information providing server and transferred to and stored into said database server, and an instruction to issue a repair completion report is issued from said terminal of said repair center, said information providing server including report issuance means for referring to the repair data in said database server to electronically issue a repair completion report from, said information providing server transmitting the repair completion report to said remote maintenance console of the repair request destination and said terminal of said distribution center thereby over the Internet.

24. A centralized maintenance management system for a portable telephone system as claimed in claim 21, wherein said remote maintenance console inputs a repair progress disclosure request in accordance with a repair progress disclosure request form of said information providing server, and said database server includes means for extracting, upon reception of the repair progress disclosure request from said information providing server, identification information of the pertaining repair request article from the repair data stored in said database server and transmitting the extracted data to said remote maintenance console in accordance with an output form of said information providing server.

25. A centralized maintenance management system for a portable telephone system as claimed in claim 21, wherein said remote maintenance console accesses said information providing server and inputs a preventive maintenance schedule preparation request in accordance with a preventive maintenance schedule preparation input form of said information providing server; a remote maintenance supporting console of said portable telephone system concentrated maintenance management system transmitting a state supervision data transfer request to said remote maintenance console through said information providing server; said remote maintenance console collecting state supervision data of radio base stations and mobile exchanges of said portable telephone system and transferring the state supervision data to said database server over the Internet; said database server including data storage means for executing a preventive maintenance schedule preparation service of storing the received state supervision data; said remote maintenance supporting console including schedule preparation means for sending an analysis request for the repair data and the state supervision data to said information providing console, analyzing the state supervision data, spare apparatus and panel inventory management data and repair data stored in said database server through said information providing server, performing fault occurrence prediction and determining a failure ratio, calculating required quantities of spare apparatus and panels and storing the required quantities as predictive maintenance schedule data into said database server; said remote maintenance supporting console preparing a preventive maintenance schedule based on the preventive maintenance schedule data stored in said database server, storing the preventive maintenance schedule into said database server through said information providing server and transmitting the preventive maintenance schedule to said remote maintenance console in accordance with a preventive maintenance schedule output form of said information providing server.

26. A centralized maintenance management system for a portable telephone system as claimed in claim 25, wherein said remote maintenance console accesses said information providing server, inputs a service request for apparatus and panel appropriate inventory management in accordance with an appropriate inventory management service request input form of said information providing server and sends the service request to said remote maintenance supporting console of said portable telephone system; said remote maintenance supporting console executes the preventive maintenance schedule preparation service and issues an instruction to produce apparatus and panels to a terminal of a production block through said information providing server based on the preventive maintenance schedule obtained by the preventive maintenance schedule preparation service; after completion of the production, apparatus and panels corresponding to a shortage are delivered into said distribution center and performs inventory management in said distribution center; and, when said remote maintenance supporting table receives a notification representing that the appropriate inventory management has been achieved from said terminal of said distribution center through said information providing server, sand remote maintenance supporting table transmits an appropriate inventory management process completion report to said remote maintenance console of the request destination using an output form of said information providing server.
